(19) United States
(12) Patent Application Publication
(10) Pub. No.: US 2015/0201567 A1
(43) Pub. Date: Jul. 23, 2015

(54) PRECISION DRILL ADAPTER

(71) Applicant: BRANON SYSTEMS, LLC, Fairfield, VT (US)

(72) Inventor: EVAN BRANON, FAIRFIELD, VT (US)

(21) Appl. No.: 14/159,949

(22) Filed: Jan. 21, 2014

(51) Int. Cl. A01G 23/10; B25F 3/00

(52) U.S. Cl. CPC A01G 23/10; B25F 3/00

(57) ABSTRACT

An adapter (10) for a power drill (12) having a threaded rod for receiving a chuck. The adapter (10) includes an adapter plate (14) for securing the adapter (10) to the drill (12); a connector rod (16) having one end connectable to the threaded rod of the drill (12) through the adapter plate (14) and another end for receiving a drill bit (17); a first sleeve (20) mountable on the connector rod (16); a second sleeve (28) slidable with respect to the first sleeve (20); a coiled spring (18) mountable around on the connector rod (16) for biasing the second sleeve away from the first sleeve; gripping pins (32, 34) at an end of the second sleeve (28) for contacting a surface to be drilled.

### FIELD OF THE INVENTION

The present invention relates to an adapter mounted on a drill for tapping specifically, but not exclusively, maple trees.

### BACKGROUND OF THE INVENTION

For at least six generations my family has been producing maple syrup in the town of Fairfield, VT. Technology and innovation have significantly changed the production process over the years from tapping trees with manual drills and gathering maple sap with buckets and horses to the utilization of less invasive battery-powered drills and sealed pipeline systems functioning by means of high-powered vacuum, respectively. As each generation has become more efficient by improving on the production techniques of the previous generation, we have also become increasingly aware of the importance of maintaining tree health. For a fifth generation maple sugarmaker in particular, the application of new technology must not only seek to increase production efficiency and reduce operating costs in the short-term. Innovation must also be concerned with sustainability in the long-run—that is to say, the health and longevity of the natural resource that is essential to the maple industry in general and the production of maple syrup in particular. With hundreds of thousands of maple trees, roughly 70,000 of which are currently used in production, and some of which have been so for as much as a century, my family's operation understands firsthand the importance of minimizing the level of invasiveness and thus limiting and ideally preventing the introduction of foreign bacteria as a consequence of the annual drilling of an incision into each tree as required for the process of sap collection. In our experience, out of the entire production process, a poor drilling technique poses the greatest threat to tree health and is the most problematic and costly issue affecting the quantity, quality, and longevity of short-term production, as well as the long-term sustainability of production as concerned with the preservation of the existing maple trees.

Tree tapping is the most important step in the process of producing maple syrup. Precision is the key to drilling a quality tap-hole. Imprecise, poor quality tap-holes are detrimental to sap production and have a negative long-term impact on tree health. The challenge is to produce a precise tap-hole with consistency.

Common problems of tapping with a standard drill include: inconsistency of the shape and depth of the hole; oblong holes which result in vacuum losses because of poor seals in the spout or adapter that are connected to the maple sap hose; holes that are overly invasive or deep; operator error, damaged bits and safety concerns. These problems may result in decreased production, increased labor costs and poor tree health.

### SUMMARY OF THE INVENTION

In order to address the above and other drawbacks, there is provided an adapter for a power drill having a threaded rod for receiving a chuck. The adapter includes an adapter plate for securing the adapter to the drill; a connector rod having one end connectable to the threaded rod of the drill through the adapter plate and another end for receiving a drill bit; a first sleeve mountable on the connector rod; a second sleeve slidable with respect to the first sleeve (20); a coiled spring mountable around on the connector rod for biasing the second sleeve away from the first sleeve; gripping pins at an end of the second sleeve for contacting a surface to be drilled.

### BRIEF DESCRIPTION OF THE DRAWINGS

FIG. 1 is a side exploded view of a power drill and adapter in accordance with an illustrative embodiment of the present invention;

FIG. 2 is an side exploded view block diagram of a drill adapter in accordance with an illustrative embodiment of the present invention; and

FIG. 3 is a perspective explode view block diagram of a drill adapter in accordance with an illustrative embodiment of the present invention.

### DETAILED DESCRIPTION OF THE ILLUSTRATIVE EMBODIMENTS

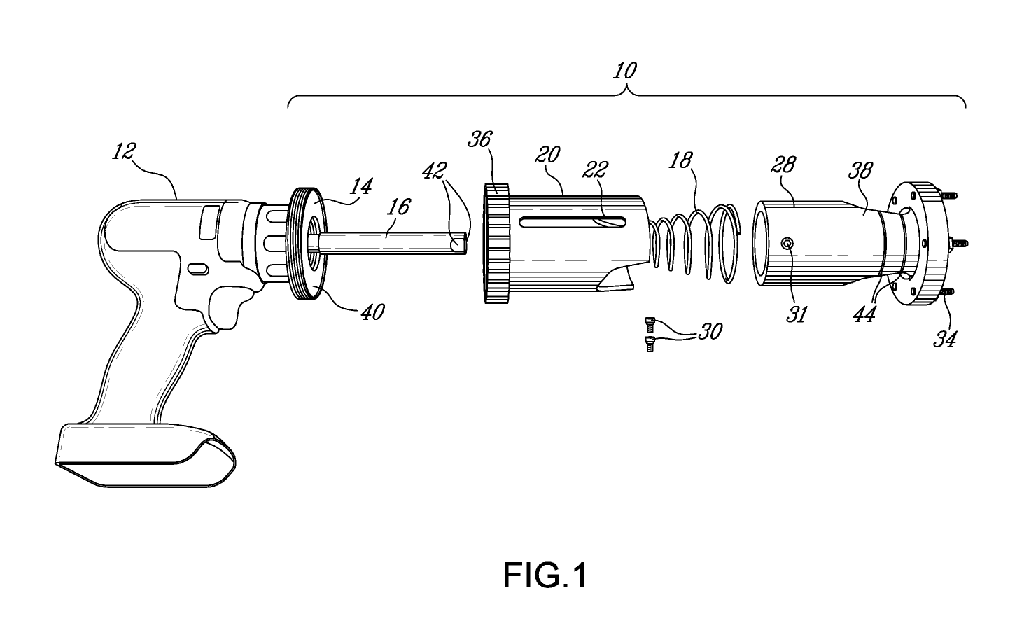

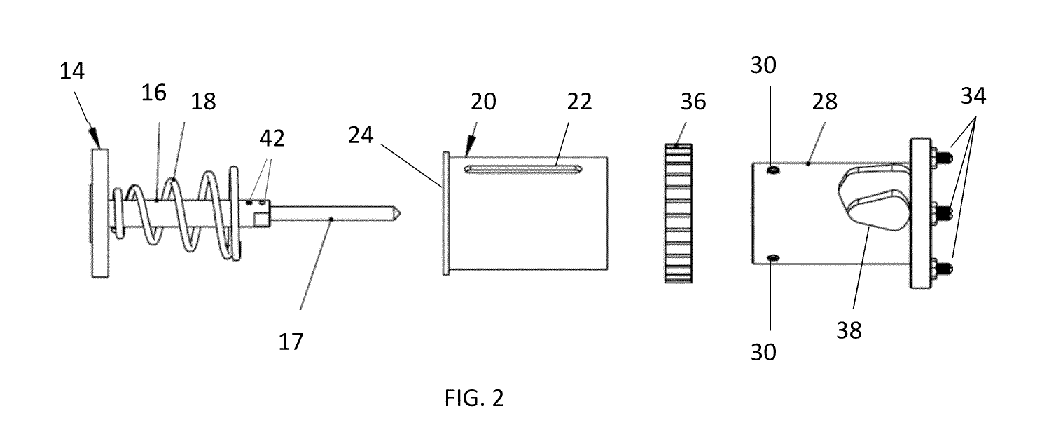

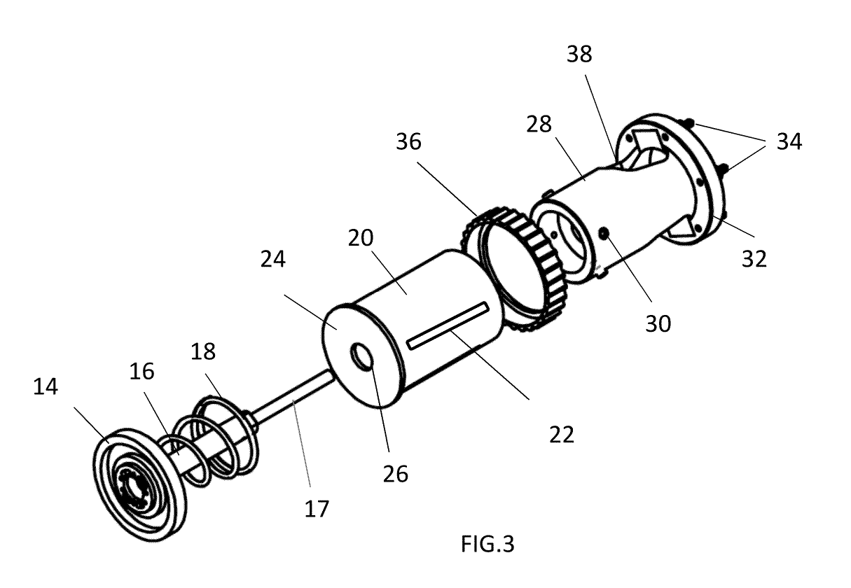

Now referring to FIGS. 1 to 3, there is illustrated an adapter 10 for a power drill 12, according to a preferred embodiment of the present invention. The adapter 10 includes an adapter plate 14 for securing the adapter 10 to the drill 12. The adapter 10 includes a connector rod 16 that has one end connectable to a threaded rod of the drill 12 in replacement of a chuck. The connector rod 16 is connected to the threaded rod of the drill 12 through the center of the adapter plate 14. The other end of the connector rod 16 is adapted to receive a drill bit 17 (shown in FIGS. 2 and 3). The adapter 10 includes an outer sleeve 20 with at least one longitudinal groove 22 and end wall 24. The end wall 24 has a central aperture 26 for receiving therethrough the drill bit 17. The adapter 10 includes an inner sleeve 28 slidable within the outer sleeve 20. The adapter 10 includes a coiled spring 18 that is mountable within the outer sleeve 20 and adapted to sit against the inside of the end wall 24 of the outer sleeve 20. In FIGS. 2 and 3, the coiled pancake spring 18 is shown mounted around the connector rod 16. However, this location of the spring 18 is for illustration purpose, and in use, the spring 18 is actually located inside the outer sleeve 20. The other end of the spring 18 is adapted to sit against an end of the inner sleeve 28. In this way, in use, the spring 18 biases the inner sleeve 28 away from the outer sleeve 20. The inner sleeve 28 has at least one guide pin 30 that may be insertable or screwed into a threaded hole 31 of the inner sleeve 28. The guide pin 30 is slidable within the longitudinal groove 22 of the outer sleeve 20. An outer plate 32 at the other end of the inner sleeve 28 is provided with a plurality of gripping pins 34. Each of the gripping pins 34 may be longitudally adjustable. The gripping pins 34 may be replaced by a fixed sized ring (not shown). One purpose of the gripping pins or ring is to contact the surface or bark of the tree to be tapped. The length of the gripping pins partially determines the depth of the hole that is made in the tree to be tapped. The gripping pins 34 may be adjusted longitudinally one with respect to the other so that they are not flush with one another and thereby provide for a small angle when tapping the tree. A nut 36 is mounted around the outer sleeve 20 and is adapted to connect to an outer threaded perimeter surface 40 of the adapter plate 14. Other ways of connecting the adapter 10 to the power drill 12 may be used, as persons skilled in the art will understand.

The depth of the hole that is made in the tree to be tapped may be precisely determined by means of two Allen set screws that are inserted in two corresponding holes 42 of the connector rod 16 that hold the drill bit 17. A user would set the depth my measuring and locking the two set screws down to the bit 17. Also on the connector rod 16 there is an internal set screw that gets bottomed out to the drill bit 17 so it does not slide inside while performing drilling. It is there to keep the bit 17 where the user wants it.

Also, as persons skilled in the art will understand, the positions of outer sleeve 20 and inner sleeve 28 may be interchanged so that the inner sleeve 20 is closer to the power drill 12 and the outer plate 32 is mounted at the end of the outer sleeve 20 instead.

In use, the adapter 10 is attached to the portable drill 12 which is then used to drill a hole into an object or through a surface or a tree. It is ideal for use in situations where drilling requires extreme precision as well as the portability of the drill itself. The materials on the end of the outer plate 32 function as a gripping mechanism, which serve to stabilize the drill against the object or surface which is being drilled so as to increase the precision of the drill and ensure an optimal drilling angle. The adapter shaft contracts with the outer shaft overlapping the inner and is adjustable, thus enabling precise control over the depth of the hole being drilled.

The adapter 10 combines the functional precision of a drill press table with the functional mobility of a battery operated portable drill.

The adapter 10 enables the drill 12 to be stabilized against a tree in order to prevent oscillations or wobble associated with an unsteady hold which result in imperfections in the size and shape of the hole being drilled. Thus, it creates a hole with a shape that forms an optimal seal with the spout or spout adapter that is being inserted into the hole.

The adapter 10 ensures that the hole is drilled into the tree at an optimal angle which is slightly less than perpendicular so as to improve sap flow and prevent the harboring of bacteria.

The adapter 10 controls the depth of the hole being drilled so as to prevent excessive and overly invasive drilling techniques.

The advantage of the grabbing pins 34 or points of contact is that these stabilize the power drill; helping maintain an angle and to duplicate the most crucial part of maple sugaring-tapping. Multiple contact points stabilize the power drill 12 against vibration and reduce wobble. In maple tree tapping it is very important to maintain a good hole and the consistency for every tree. Vacuum systems can be easily disrupted and with an improper seal (leak) and production will decrease. As well, the sugarmakers' vacuum infrastructure may be damaged and not up to full potential. The health of the tree is also a factor to consider. A large angle to the tree will take longer to heal due to an oblong hole. Many sugarmakers, when they find a leak at the tap-hole, may choose to re-tap the same tree providing another scar to the maple tree.

The inner sleeve has two openings 38 for viewing the drill bit 17. Depth indicator markings 44 may be provided on the inner sleeve 28 next to these openings 38.

The inner and outer sleeves 20, 28 help to extend the overall life of a drill bit by reducing breakage and preserving profile.

The internal bit design protects the operator from contact with the sharp drill bit, thus enhancing safety.

Some of the advantages of using the adapter according to the present invention may lead to: reduce vacuum leakage with a better tap-hole seal; prevent the introduction of bacteria inside the tap-hole; by improving the quality of the tap-hole and reducing instances of re-tapping; enhance sap production by minimizing error and matching production to potential; decrease labor costs by drilling it right the first time; increase overall productivity because improving the procedure improves the results.

Although the present invention has been described hereinabove by way of specific embodiments thereof, it can be modified, without departing from the spirit and nature of the subject invention defined in the appended claims.

1. An adapter (10) for a power drill (12) having a threaded rod for receiving a chuck, the adapter (10) comprising:
an adapter plate (14) for securing the adapter (10) to the drill (12);
a connector rod (16) having one end connectable to the threaded rod of the drill (12) through the adapter plate (14) and another end for receiving a drill bit (17);
an outer sleeve (20) with at least one longitudinal groove (22) and end wall (24) for contacting the coiled spring and an aperture (26) for receiving through the drill bit (17);
an inner sleeve (28) slidable within the outer sleeve (20), the inner sleeve (28) having at least one guide pin (30) slidable within the longitudinal groove (22);
a coiled spring (18) for biasing the inner sleeve (28) away from the outer sleeve (20), the coiled spring mountable within the outer sleeve (20) and around the connector rod (16), the coiled spring having one end for sitting against the wall (24) of the outer sleeve (20) and another end for sitting against the inner sleeve (28);
an outer plate (32) connected to the inner sleeve (28), the outer plate (32) having a plurality of gripping pins (34) for gripping the surface to be drilled, each of the gripping pins being longitudally adjustable.

2. The adapter of claim 1, where the plurality of gripping pins comprises six gripping pins.

3. The adapted of claim 1, comprising a nut (36) for connecting the outer sleeve (20) to a threaded perimeter surface (40) of the adapter plate (14).

4. The adapter of claim 1, wherein the inner sleeve comprises at least one opening (38) for viewing the drill bit (17).

5. An adapter (10) for a power drill (12) having a threaded rod for receiving a chuck, the adapter (10) comprising:
an adapter plate (14) for securing the adapter (10) to the drill (12);
a connector rod (16) having one end connectable to the threaded rod of the drill (12) through the adapter plate (14) and another end for receiving a drill bit (17);
a first sleeve (20) mountable on the connector rod (16);
a second sleeve (28) slidable with respect to the first sleeve (20);
a coiled spring (18) mountable around on the connector rod (16) for biasing the second sleeve away from the first sleeve;
contact means (32, 34) at an end of the second sleeve (28) for contacting a surface to be drilled.

6. The adapter of claim 5, wherein the contact means comprise an outer plate (32) connected to the second sleeve (28), the outer plate (32) having a plurality of gripping pins (34) for gripping the surface to be drilled, each of the gripping pins being longitudally adjustable.

7. The adapter of claim 5, comprising a nut (36) for connecting the first sleeve (20) to a threaded perimeter surface (40) of the adapter plate (14).

8. The adapter of claim 5, wherein the first sleeve (20) has at least one longitudinal groove (22) and end wall (24) for contacting the coiled spring (18) and an aperture (26) for receiving through the drill bit (17); and the second sleeve (28) is slidable within the first sleeve (20), the second sleeve (28) having at least one guide pin (30) slidable within the longitudinal groove (22);

9. The adapter of claim 8, wherein the contact means comprise an outer plate (32) connected to the second sleeve (28), the outer plate (32) having a plurality of gripping pins (34) for gripping the surface to be drilled, each of the gripping pins being longitudally adjustable.

10. The adapter of claim 9, comprising a nut (36) for connecting the first sleeve (20) to a threaded perimeter surface (40) of the adapter plate (14).
